(19) United States
(12) Patent Application Publication
(10) Pub. No.: US 2016/0019491 A1
(43) Pub. Date: Jan. 21, 2016

(54) Systems and methods for management of field staff based on ranked individual profile attributes and availability

(71) Applicants: Giuseppe Arlia, Garden City, NY (US); Timothy Sullivan, Garden City, NY (US); Alex Teplish, North Woodmere, NY (US)

(72) Inventors: Giuseppe Arlia, Garden City, NY (US); Timothy Sullivan, Garden City, NY (US); Alex Teplish, North Woodmere, NY (US)

(21) Appl. No.: 14/799,618

(22) Filed: Jul. 15, 2015

Related U.S. Application Data
(60) Provisional application No. 62/025,423, filed on Jul. 16, 2014.

(51) Int. Cl. G06Q 10/06; G06Q 10/10

(52) U.S. Cl. CPC G06Q 10/063112; G06Q 10/063118; G06Q 10/1091

(57) ABSTRACT

A computer-based system for management of field staff may include a central computer server and a plurality of mobile devices for communication with individual staff. The central computer server may be configured to generate individual notifications to at least a selected portion of the individual staff, and communicate these notifications to respective mobile devices assigned to this selected portion of individual staff. Upon receipt of at least some confirmations, the central server may generate and communicate individual barcodes to all responders. These barcodes may be used to register an individual staff upon arrival and record working hours while at the field event.

### CROSS-REFERENCE DATA

This patent application claims priority date benefit from a U.S. Provisional Patent Application No. 62/025,423 with the same title and filed on 16 Jul. 2014, which is incorporated herewith by reference in its entirety.

### BACKGROUND

The invention relates in general to coordination of field staff and communication via cellular or other wireless networks. In particular, the invention relates to supporting or implementing functionality to provide increased communication and tracking capability of personnel to staff a field event using wireless devices, as specified in the independent claims.

Properly scheduling and staffing a field event is a difficult task. Such event may be for example a catering event, which requires a number of skilled and unskilled staff. Inviting staff from a pool of available human resources as well as tracking staff arrival and work hours may present a difficulty for a large-scale event.

As is conventionally known in the management of staff working in the field and/or remote from an organization's offices, individual field staff members are often difficult to contact in order to invite them to arrive at the site of an event and track their work time throughout their workday. As a result, it is often difficult to adequately schedule suitable staff for a particular event, as well as determine or verify their time at work or on particular tasks/jobs for the purposes of payroll or billing. Moreover, staff working in the field routinely record their time manually on a particular job/task as well as the total time at particular job sites. However, this type of recordation, for the purposes of keeping track of field staff and also for billing customers, is susceptible to problems when staff are disorganized, not diligent or dishonest in their recordkeeping. Moreover, the management and analysis of the manually recorded time entries requires office staff to reenter all the data into an organization's accounting system, which is, of itself, time consuming and susceptible to human error.

New systems and methods are therefore needed allowing the flexibility to manage the field staff based on their ranked skill sets and availability.

### SUMMARY

It is an object of the present invention to provide an improved system for management of field staff.

It is another object of the present invention to provide a system for improved recordkeeping of staff arrival, working time and departure associated with a planned field event.

It is yet another object of the present invention to provide a system for management of field staff with improved flexibility and ability to change or add staff in real time as demand for such staff changes just prior to or even during the implementation of the field event.

In embodiments, a computer-based system for allocation and management of field staff may include a central computer server having an automatic staff allocation engine configured to assign individual staff to a planned event. The staff allocation engine may be operably connected to a number of other components including:
a staff records keeping roster,
a staff database including an individual staff profiles database and an individual availability database,
an allocation rules database, and
an automatic notification engine.

The staff allocation engine may be further configured to assign the individual staff to the planned field event based on ranked individual staff profile attributes and staff availability.

The system of the invention may further include a manager user interface operably connected to the central computer server, which may be configured to create an entry for the planned field event and request staff therefor.

The system of the invention may further include a plurality of individual staff communication devices such as smartphones or computer tablets configured to receive notifications from the automatic notification engine. In embodiments, such communications between the central computer server and individual staff may be conducted over the Internet using cellular, wireless, wired or other types of communications.

In further embodiments, the computer-based system for management of field staff may include a central computer server and a plurality of mobile devices for communication with individual staff. The central computer server may be configured to generate individual notifications to at least a selected portion of the individual staff, and further configured to communicate these notifications to respective mobile devices assigned to this selected portion of individual staff. The central computer server may further be configured to receive confirmations from at least some of this selected portion of individual staff, in which case the central server may then be adapted to generate and communicate individual barcodes to all responders. These barcodes may be QR codes and may have limited time applicability corresponding to a timeframe for a planned field event. The system of the invention may be further configured to utilize each of said barcodes to (i) register an individual staff upon arrival to the field event and start a record of working hours for the individual staff; and (ii) stop recording of working hours when the individual staff leaves the planned event, whereby recording a full account of working hours for this individual staff at the field event. The system can also account for staff breaks such as process check-in/checkout sequences continually.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a general block-diagram of the system for management of field staff.

FIG. 2 is a general outline of workflow steps.

FIG. 3 is an outline of the details of mobile steps mentioned in FIG. 2 under “See Process”.

FIG. 4 depicts a more detailed system workflow from the perspective of staff member interaction, application features and Manager's action.

FIG. 5 depicts the system workflow from the point at which individual staff is invited to a field event.

FIG. 6 depicts Staff on the Fly™ functionality of the present invention.

FIG. 7 illustrates a process by which the Event Captain may utilize the StaffSmart Scanner application to check-in/check-out individual staff who report to a field event.

FIG. 8 shows the entire system workflow process from the point in which the Staff defines his or her availability.

### DETAILED DESCRIPTION OF THE INVENTION

The following description sets forth various examples along with specific details to provide a thorough understanding of claimed subject matter. It will be understood by those skilled in the art, however that claimed subject matter may be practiced without one or more of the specific details disclosed herein. Further, in some circumstances, well-known methods, procedures, systems, components and/or circuits have not been described in detail in order to avoid unnecessarily obscuring claimed subject matter. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

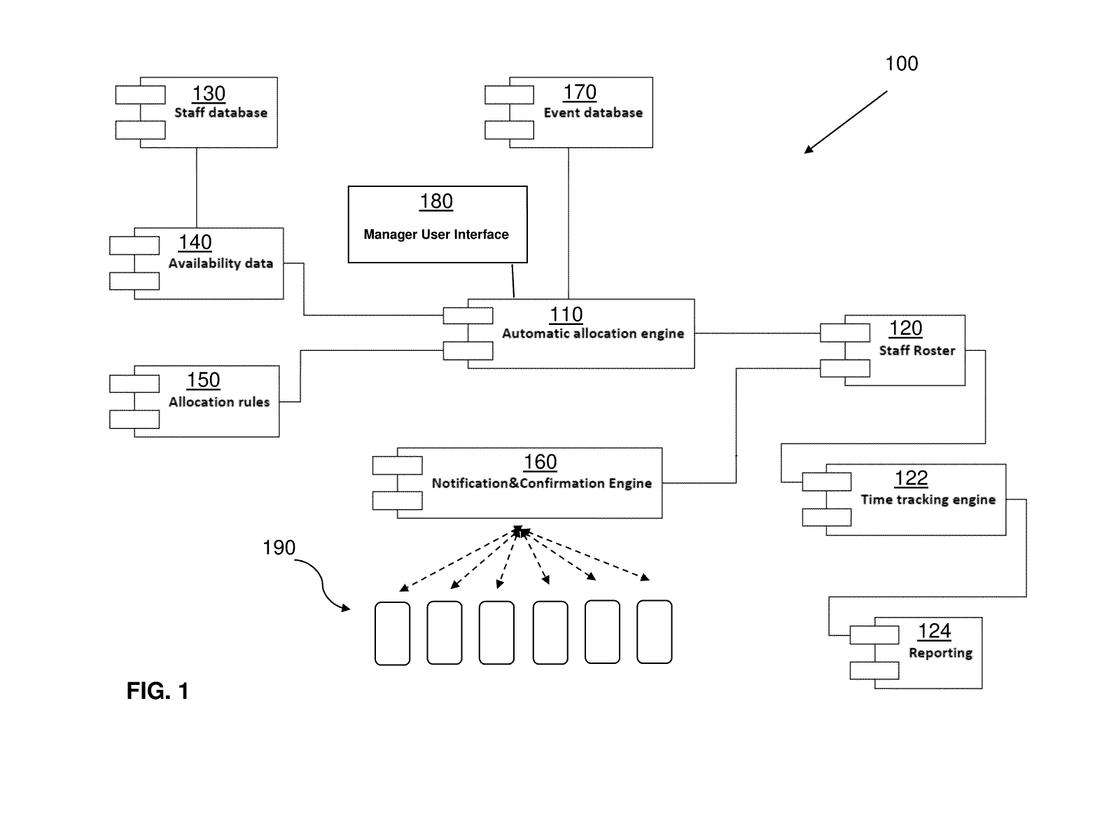

FIG. 1 shows a general block-diagram of the system for management of field staff according to at least some embodiments of the present invention. The system may include a central computer server 100 having an automatic staff allocation engine 110, which may be configured to assign individual staff to a planned event, which may be selected from or created using an event database 170. The staff allocation engine 110 may also be operably connected to a staff records keeping roster 120 and a staff database 130, which in turn may include an individual staff profiles database, an individual staff availability database 140, and an allocation rules database 150. The system 100 may further include an automatic notification engine 160, which may be configured to communicate with a plurality of individual staff communication devices 190. Importantly, the automatic staff allocation engine 110 may be configured to assign individual staff to a planned event based on based on ranked individual staff profile attributes and availability, as well as based on other criteria described below in greater detail. The system 100 may further include a manager user interface 180 operably connected to the central computer server 100 and configured to create said planned event and request staff therefore.

The following is an expanded description of the major elements of the system 100.

The Staff Database 130 is a general repository to store all data related to Staff information. This and other elements of the system described below may be based on a computer memory device generally known in prior art, for example embedded or removable memory disks etc. Staff Database 130 may include files and records separated into two sections: a first section may contain basic staff information such as for example First Name*, Last Name*, Email*, Cell Phone Number*, Home Phone Number and Log-in activation button (On/Off). The second section may contain Profile information to include for example Hire Date, Certifications, Hourly Rate*, Languages Spoken, Position Type*, Address, City, State, Date of Birth*, Available for Allocation (On/Off) and Available for Staff-on-the-Fly invitations (On/Off) and so on.

The Availability Database 140 may be operably connected to the staff database 130 and may contain staff-specific information based on Staff adding their work availability in the system calendar tool. Availability refers to the times and specific calendar days the individual staff reports as available for work. The system may be configured to allow staff members to individually set and revise their personal availability on a periodic basis such as weekly. Custom times may also be individually entered to indicate availability or unavailability as desired. The system may be further configured to allow staff to only view their own availability and have the option to view their individual calendar by day, week, or month. Staff can also confirm or decline assignments/invitations from their individual calendars. Booking information for the staff may be stored here as well. Once entered, booked periods are considered as unavailable periods for other events by the allocation engine.

In other embodiments, in addition or in other cases separately from entering their availability in advance, individual staff may simply go “online” and “offline” as desired. Once online, the system may be configured to assign that individual staff to a field event. This “on demand” real-time availability may be particularly useful when rapid changes in staff needs occur just prior or during the ongoing event.

The Allocation Rules database 150 may be operably connected to the automatic allocation engine 110 and contain customizable rules, which the system 100 may use to search and allocate staff for a particular Event. There may be 2 sets of rules: a standard set of rules and a customized set of rules. The standard set of rules may be applied to the allocation engine 110 by default. Examples of standard rules are position type, availability, OverTime hours limit, Spread of Hours labor rules, etc. The allocation engine 110 may be configured to select the appropriate staff for a particular event using the standard set of rules as a higher priority than other considerations.

The Allocation rules database 150 may also store a custom set of rules based on client preference or requests. Examples of custom rules can be a limit on Staff Length of Time worked, Staff Language Skills, Staff Certifications, etc.

The Event Database 170 may be a repository to store all data related to Event information. There may be up to 6 sections that make up this database. They may include General Information, Staff Openings, Event Planner, Staff Meeting Information, Information for Management and Special Requirement Notes. The General Information section may be used to store basic event information such as Event Name*, ID (can be used for internal purposes to identify event and can also be used as unique field for integration to and from other systems), Type of Event*—optionally as a dropdown menu, which can store many different types of Event the user can select such as: Afternoon Break; Breakfast Buffet; Cocktail reception; Dinner Buffet, Grazing Stations; Lunch Buffet; Seated Dinner and Wedding (this field can be configured per client request and the system may permit unlimited options that can be manually added). Other fields may include Start Time and Date, End Time and Date, Number of Guests, Number of Children, Description of the Event, Event Address*, City*, State* and ZIP*.

The Staff Openings section of the Event Database 170 may be configured to allow users to allocate the individual Staff they need to the desired field Event. The users may select the Position Type of the Staff they need—for example using a dropdown menu. This dropdown menu may store such values as Event Captain, Lead Captain, Buffet Captain, Bar Captain, Server, Sanitation Captain, Sanitation Assistant, Line Cook, Kitchen Assistant, Bartender, Attendant, Event Chef and Chef. These field values are only exemplary and may be configured to add or remove values from the dropdown menu. This flexibility may be useful not only for client requests but also to use in other industries.

The Event Planner section of the Events Database 170 may store the contact information such as the Name* of the Event Planner who is in charge of setting up a particular Event. The Event Planner's Phone Number and Email Address may also be included here.

The Staff Meeting Information section of the Event Database 170 may store data related to a specific meeting place for the Staff working at the Event. This may include information on whether transportation will be provided, Meeting Address, Meeting City, Meeting State and Meeting ZIP.

Information for Management section of the Event Database 170 may store Client Name, Client Contact Person, Client Contact Person Office Phone Number, Client Contact Person Email and Client Contact Person Mobile Phone Number. This section may also contain Event Notes or Captain's Notes.

Special Requirement Notes section of the Event Database 170 may contain any special requirements noted by Event Planner.

Automatic allocation engine 110 is the most critical element of the system of the invention, which may be configured when requested to search for the Staff from Staff Database 130 based on Availability data 140 and allocation rules in 150. Once available staff is found, the automatic allocation engine 110 may be configured to create a new booking record with status set to “allocated” for the staff during the requested period, which means that the staff became not available for this period.

Staff Records Keeping Roster 120 may be a computer subsystem, which keeps staff allocation data (defined as relations between staff, booked period and event opening), displays a pool of confirmed Staff who can work at a particular Event. The roster 120 may allow an authorized Event Captain to review allocated individual staff, record and track their worked time, request Staff-on-the-Fly (see below for a detailed description) and provide feedback for the staff.

Notification and Confirmation Engine 160 is envisioned as to send out various notifications to staff and managers. Such notifications may be created and triggered by other subsystems. For example, once Staff is allocated and Event Planner requests to invite allocated staff for the Event, the notification engine 160 may first send out notifications via email, text message, instant message or other known modern communication means indicating that Staff has been invited to work at a particular Event. Once Staff accepts assignment to the Event, the notification engine 160 may be programmed to send a second communication message confirming the Event and including a unique QR-code for Staff for this Event.

The notification engine 160 may be configured to generate automatic messages and send those to staff assigned to events:
Individualized communications such as email invitations may be sent to staff to invite them to a particular event to which they have been selected by the allocation engine 110;
In response, the Staff may have the ability to either Accept or Decline the invitation;
If the invitation is accepted, the Staff may receive an additional email with confirmation and a unique individual barcode such as a QR code assigned to them and only for that event (described in greater detail below);
If the invitation is declined, the system may automatically find a replacement staff and the process above may be repeated;
The system of the invention may automatically decline the invitation if staff does not respond with a user-defined period of time;
Staff may be able to cancel the invitation after it has been already accepted—the system in that case may be configured to automatically find a replacement.

Time Tracking Engine 122 may be configured as a subsystem to the Staff Records Keeping Roster 120. The time tracking engine 122 may keep track of Staff worked hours by calculating time from a point of Check-in to the point of Check-out for each Event. The time tracking engine 122 may store data of every check-in and check-out for specified staff allocation to the event and calculate worked hours based on collected data. The worked hours data may in turn be used by the automatic allocation engine 110 to apply limits from the corresponding Allocation Rules database 150.

Reporting Database 124 is envisioned as a system which may generate one or a series of predefined reports related to the application and Staff activity, for example as follows:
Staff Not Worked—report which shows the inactivity of Staff who have not worked in 1 month, 2 months, 3 months and 6 months;
Number of Cancellations—report which shows the number of times Staff has cancelled an already accepted assignment. Period of time can be displayed in 1 month, 2 months, 3 months and 6 months;
Number of Late Shows—report which shows number of times Staff has been late showing up to an Event. Period of time can be displayed in 1 month, 2 months, 3 months and 6 months. The system default may be 15 minutes, but it can be configurable by the user;
Extra Worked Hours—report which shows the number of extra hours Staff has worked for the Event. Period of time can be displayed in 1 month, 2 months, 3 months and 6 months. The system default may be 15 minutes but can be configurable by the user;
Upcoming Events—report which shows a list of upcoming events with Position Types for the Event and assigned Staff along with Planned Start Date and Time, Planned End Date and Time. Time interval for this report may be next 5 days, next 30 days, next 90 days or unlimited;
Total Overtime—report which shows Overtime hours incurred by Staff and their Position type. Overtime hours may be divided weekly over the course of a 4 week period. Total overtime hours may also be displayed;
Actual vs Planned Hours—report which shows Event Name, Event Start Date and Start Time, Event Start Date and End Time, Planned Hours for the Event, Worked Hours for the Event and the Difference between Planned vs Worked hours. Period of time can be displayed in 1 month, 2 months, 3 months and 6 months;
Number of Shifts—report which shows the Staff Name, Event Position assigned to Staff, Number of Shifts Available to that Staff, Number of Shifts that Staff Worked and the Difference between Available vs Worked. Period of time can be displayed in 1 month, 2 months, 3 months and 6 months.

The hardware elements of the system of the invention may operate together using at least some or all of the following additional considerations.

Included in the system may be a Firewall to prevent access from non-authorized hosts to the application server and its infrastructure management interface, and only https protocol to standard ports may be allowed. Email servers and database servers may be available only from specified IP addresses for maintenance and from the application server, any access from other Internet addresses may be blocked by the firewall.

In addition, the Application server may run application code which implements business logic, data access logic and service logic. The Application server may accept requests using secure https protocol.

An Office User or a Mobile User with a laptop or desktop computer or a mobile device using a web browser may send requests to the Application server, which may be configured to then process such requests and return a response to the user's web browser to display.

When an Office User or a Mobile User attempts to access the system Application, the Application server may first perform an authentication procedure for the user, and then apply user-specific role(s) and grant user-specific permissions.

In further embodiments of the system, the settings section may include an option to record compliance of individual staff. Standard or customized (per human resources policies) fields may include for example “Did not wear proper entire”, “Rude to guests”, “Late to work”, “Intoxicated during work”, etc. as well as free notes section which can be used to enter any remarks related to compliance. Compliance notes may be viewed in staff profile portion of the system.

### Intelligent Staff Allocation Functionality

In use, the above described system may be configured for optimum management of individual staff during the planning and execution phases of the Event. It may be configured to assure smooth staff allocation and accurately track working hours based on the following guiding principles:
Based on the position type and quantity entered by the user, the system may check through logic and predefined rules (at least some of which may be user-configured) to see what staff can automatically be assigned to the event;
The system of the invention may be configured to assign the staff, which fit the specific criteria (position type matches or follows hierarchy, is active, calendar shows availability, etc) AND also will not go over the limit of weekly allowed hours or violate Spread of Hours or any other applicable labor laws. Both overtime and Spread of Hours values can be configured by the user;
The User may have the ability to override or replace system-generated staff by clicking on an optional Replace button
The User may have an ability to automatically schedule staff X # of days before an event

In embodiments, the authorized user may be able to override automatic staff allocation with a manual entry.

Arrival and/or departure of staff to the event location may be recorded using one of three possible means:
Manually by Event Captain checking a box for each requested staff member on a tablet computer for example;
Automatically—by employing GPS tracking system uniquely configured for each staff member. In one example, a mobile phone GPS tracking software may be activated for the time period of the scheduled event and check a staff member in when his cell phone is detected to be in close proximity to the event location. The system may check that staff member out when the GPS coordinates of his phone are detected to be away from the event location;
Semi-automatically—by Event Captain scanning a unique bar code generated for the each staff member and operable within a limited period of time corresponding to the expected time of the event.

In embodiments, the system of the invention may feature using individual barcodes, and in particular a QR code to record arrival of the staff to the event and departure of the staff after the event. Unique QR code process for staff to Check-in/Check-out may include the following attributes:
May be developed as an app for any suitable Android, Apple, or Microsoft platforms—such that the staff may use a regular smartphone for displaying the code;
A QR code scanner app may be developed in addition to a display of the code on the smartphone in order to read QR code of staff looking to check-in and check-out of worked event;
QR code is unique to the assigned staff member and has limited time activity—can be used only for the purposes of a particular event.
It may also be used to record and calculate the worked time (check-in to check-out or with reported breaks)

In this case, each staff member is expected to have a personal or company-issued mobile device configured to display the QR codes such as a smartphone or a computer tablet and further configured to communicate with the central computer server via a cellular, wireless or wired connection to an Internet. (individual staff may also present printed version of the QR code—upon confirmation and acceptance of the field event individual staff may have the ability to print out and present the QR code as an option). In further embodiments, continuous connection to the Internet may not be required. Intermittent synchronization of all entries from time to time or on a periodic basis may be sufficient to operate the system. In one example of such system, Event Captain may check in all individual staff, run the event and check everyone out using a personal computer, a cell phone or a tablet. Once Internet connection is established, all working hours may be transmitted to the central server for processing of payments and other record keeping. This configuration may be particularly useful in locations where Internet access may be difficult or unreliable.

Although the description of the present invention is written in terms of barcodes, the techniques described herein are not limited to any specific form of encoding, but can be used with any optical machine-readable representation of data, including linear barcodes and matrix (2D) barcodes. Although most barcodes are black and white, some vendors have introduced barcodes that encode data using color elements instead of black and white. For example, Microsoft Corporation has developed a 2D barcode known as a High Capacity Color Barcode (HCCB) that uses clusters of colored triangles instead of square black and white pixels as used in many other 2D barcodes.

In addition to the above features, the system of the present invention may be equipped to handle last minute staff cancellations and no-shows using a so-called Staff on the Fly™ feature for last minute staffing needs and changes. If there is a NO SHOW of a particular staff for a given position or positions, the system may have the ability to send last minute notification to fill that position (system will preferably send such notifications to staff which have opted-in to receive Staff on the Fly™ notifications). The system may also be configured with the ability to fill several staff for a given position (i.e. Bartender does not show up at an event, Captain realizes that Bartender is a NO SHOW but he/she feels 1 replacement is not enough and can then select a higher quantity of respective staff from dropdown box under Staff on the Fly™ feature) and the system will ask look to fill that quantity of staff. Finally, Staff who opt in may have first-come first-serve preference to respond to Staff on the Fly™ notification—those who respond fastest will get the assignment.

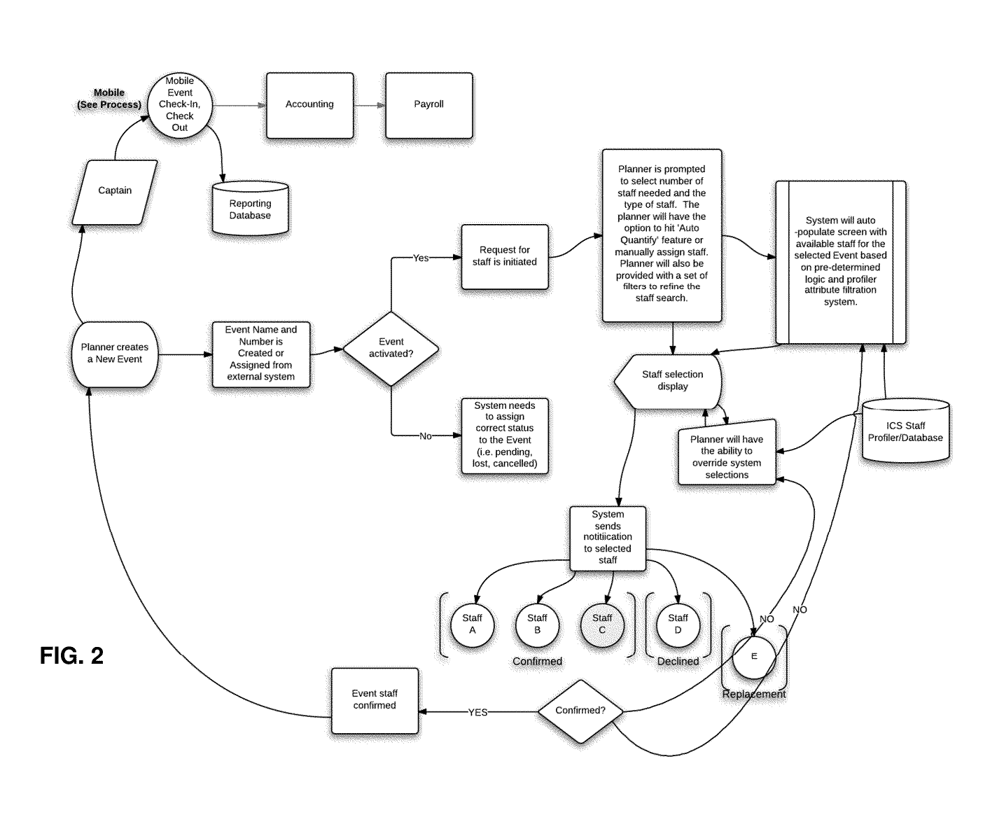

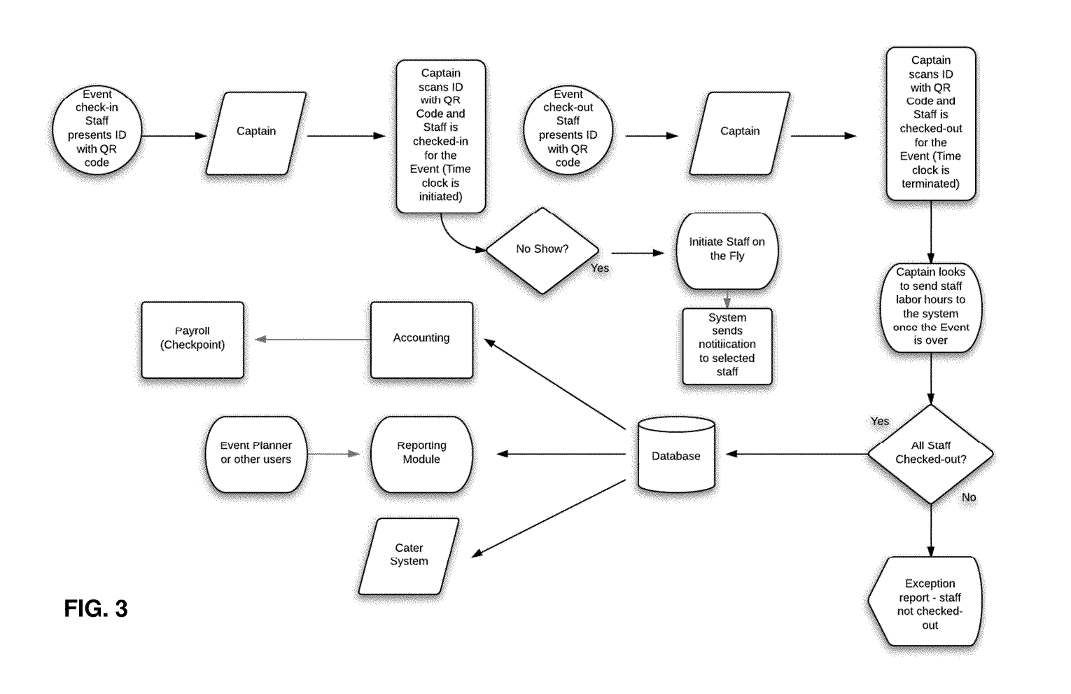

To better explain how the system operates, reference is made to FIGS. 2 and 3 outlining exemplary general workflow steps as follows:

1) Event Planner creates New Event;
2) System assigns Event Number and stores Event in database or uses an existing Event Number from an external system;
3) If Event is activated, the system may initiate the request for staff options; if Event is not activated, the system may only assign a status to the Event for historical and reporting purposes;
4) Event Planner is prompted to select staff type and number of staff needed for the specific Event;
4a) If ‘Auto Quantify’ option is selected, the system may provide results based on predetermined logic and any refinement filters selected;
5) System may display search results based on ‘Auto Quantify’ feature or manual selection; Planner may have the ability to override system selections (Log initiated);
6) System may then send notification (email or text) to staff selected for the specific Event;
7) Staff response may then be required: options may be presented to Staff to Confirm or Decline Event work order;
7a) if Staff Confirms Event work order, the staff list may then be sent to Event Planner;
7b) if Staff Declines Event work order, the system may send a request to regenerate a replacement and step 7 may then be repeated;
   8) Event Planner reviews staff list and sends to Event Captain;
   9) Mobile App Process may then be initiated: Event Captain may access the app on his or her mobile device and process staff check-in and check-out at the Event;
   10) Upon conclusion of the Event and all staff checking out, the system may send data to Staff Record Keeping Roster and to accounting to generate staff labor hour for Staff;
   11) Accounting may in turn send staff labor hours to Payroll.
   A subset of steps constituting step 9 above is outlined in FIG. 3 as Mobile Workflow Steps:
   9a) Event Staff locates Event Captain and check-in to work the Event;
   9b) Event Captain uses mobile App to scans ID (QR code) and check-in Staff;
If NO SHOW is detected for some of the Staff, the Event Captain can initiate Staff on the Fly™ feature for exact replacement amount or additional staff;
   9c) Upon the conclusion of the Event, Staff locate the Event Captain and check-out of working the Event;
   9d) Event Captain may use the mobile App to scan ID (QR Code) and check-out Staff;
   9e) System may then process the request to send data to system database;
   9f) System verification may then occur to make sure all assigned staff has checked-out;
   9g) If 1 or more of the Staff has NOT checked out, the system may send an Exception Report;
   9h) If all Event Staff has checked-out, the system may calculate labor hours and send data to Staff Roster;
   9i) Staff Roster may send Event data to Accounting system;
   9j) Staff Roster may send a copy of data to Reporting Module;
   9k) Staff Roster may also send a copy of the data to any integrated Catering systems;
   9l) Accounting system may send Event labor expenses to Payroll; and
   9k) Reporting Module may be accessible by Event Planner and/or authorized users.

The system of the invention may be further configured to allow authorized staff (such as Event Planner or Event Captain) through a manager user interface to override automatic selection of staff and several other features as described above. Customization of the system may be offered to a client company allowing various degrees of manual override power.

In embodiments, the system of the invention may be further customized to include the ability for management to generate and export various reports associated with a field event. Examples of such reports include an Actual vs Planned Hours Report, a Staff Hours Worked Longer Than Scheduled Report, and a Total Overtime Report.

In further embodiments, the system may be customized to allow to multiply staff positions and rates per person. In this case, Staff Manager may have an ability to create/edit/remove position set for a staff (Staff Page), such as (i) Change data model to introduce position-rate sets, (ii) Implement corresponding controller for Create/Read/Update/Delete sets and position/rate pairs for sets, (iii) Change staff profile user interface to manage position/rate sets, (iv) Implement validations on remove positions or change rate in case there are planned allocations for it.

In further embodiments, the system may include a notification about a required uniform for a particular field event.

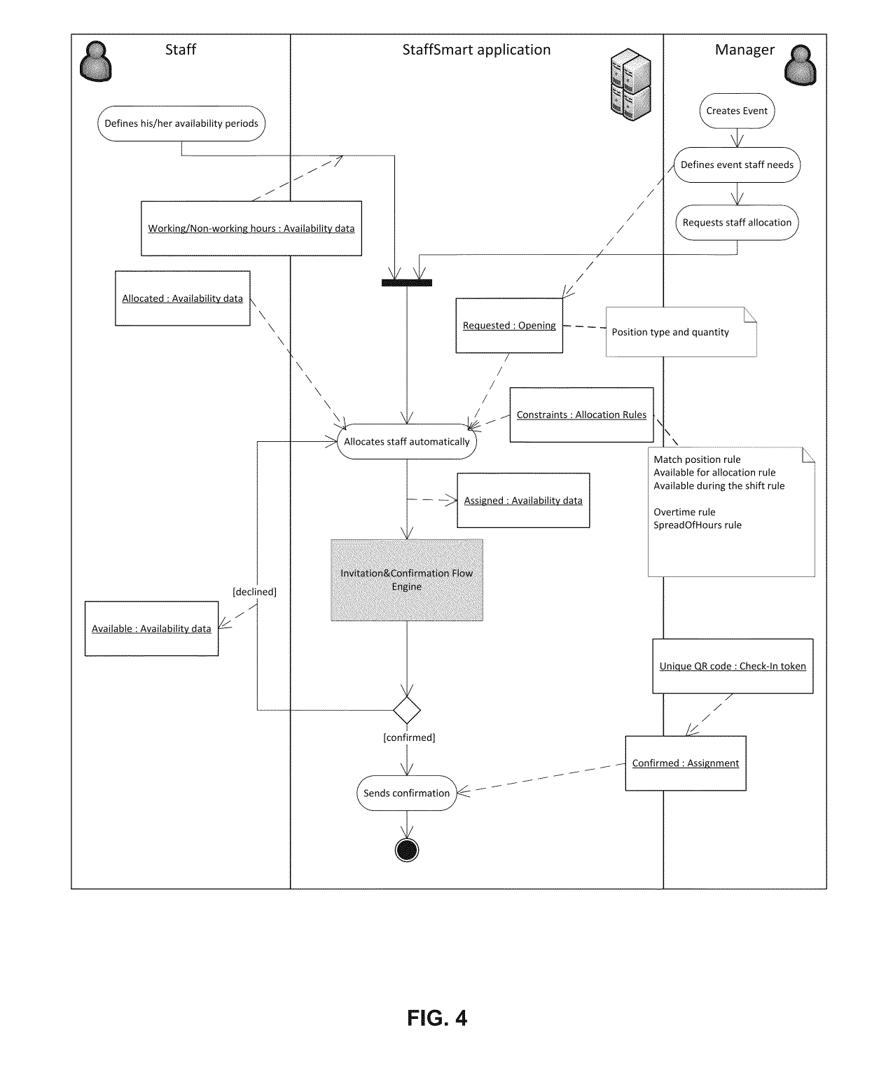

Additional details and configurations are illustrated in FIGS. 4-8 of the attached drawings. FIG. 4 depicts a more detailed system workflow from the perspective of staff member interaction, application features and Manager's action. An individual Staff member may define his/her availability, which may then be stored in the application to be later used for allocation logic. Manager may create an Event and allocate staff needs by requesting the system to do so. Based on logic and stored allocation rules, the system of the invention may be caused to provide results to the Manager. Once the Manager has decided on the appropriate staff, the system may be programmed to send out notifications to those staff selected for this Event. If the Staff accepts, he or she may receive a unique QR code to present at the Event for check-in/checkout. If the Staff declines the invitation, the application may automatically look for a replacement and the process may be repeated again until an appropriate number of the Staff confirms their availability.

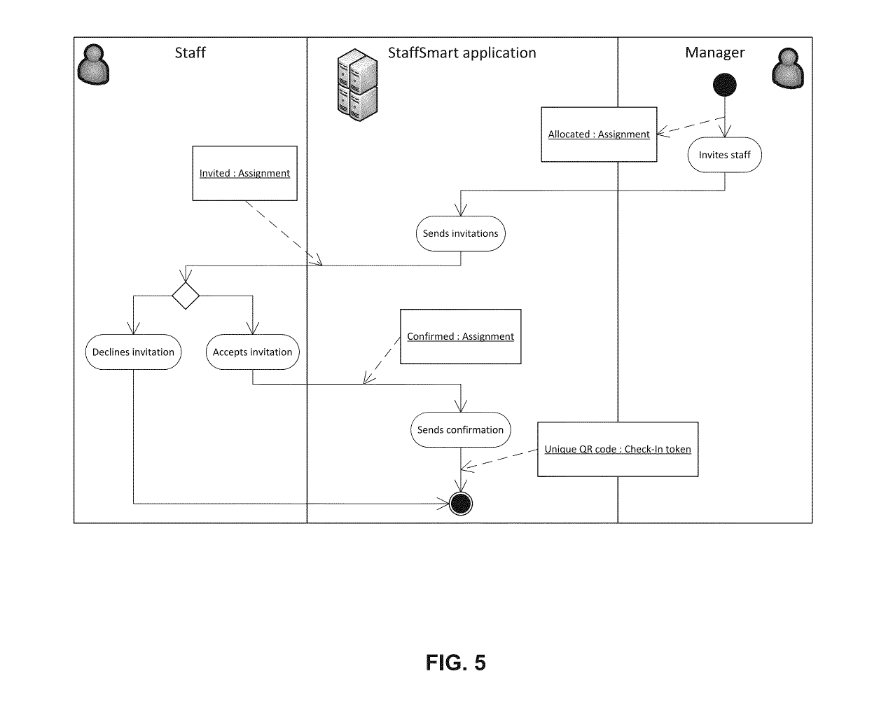

FIG. 5 depicts the exemplary system workflow from the point at which staff is invited to an Event. The system may send out invitations to individual staff which they have an option to either accept or decline. If accepted, the staff may receive a confirmation message with a unique QR code. This QR code may be used by the staff to check-in/check-out at the Event. If the Staff declines, the system may attempt to find a replacement from the application.

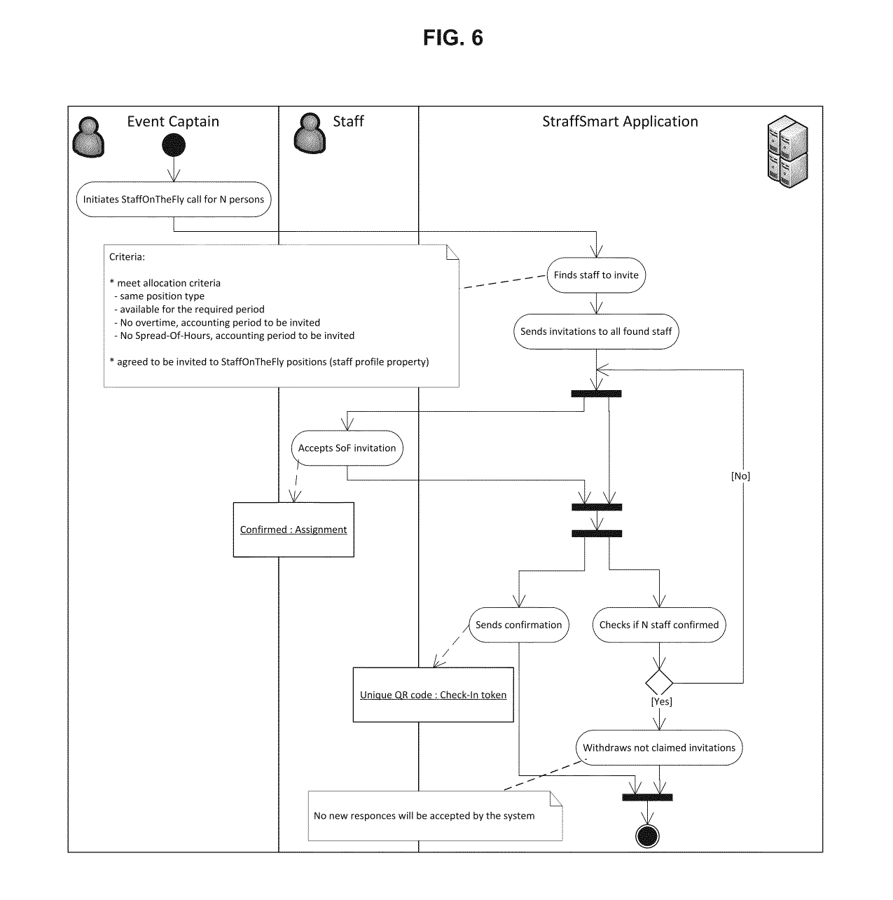

FIG. 6 depicts Staff on the Fly™ functionality from the point at which Event Captain may invite additional staff to work that field Event. If staff has opted-in to receive such last minute notifications and is available for work, the system may notify them and allow an opportunity to accept or decline. If accepted, the staff may receive confirmation message with a unique QR code. This QR code may be used by the staff to check-in/check-out at the Event. If the Staff declines, the system may attempt to find another replacement from the staff roster.

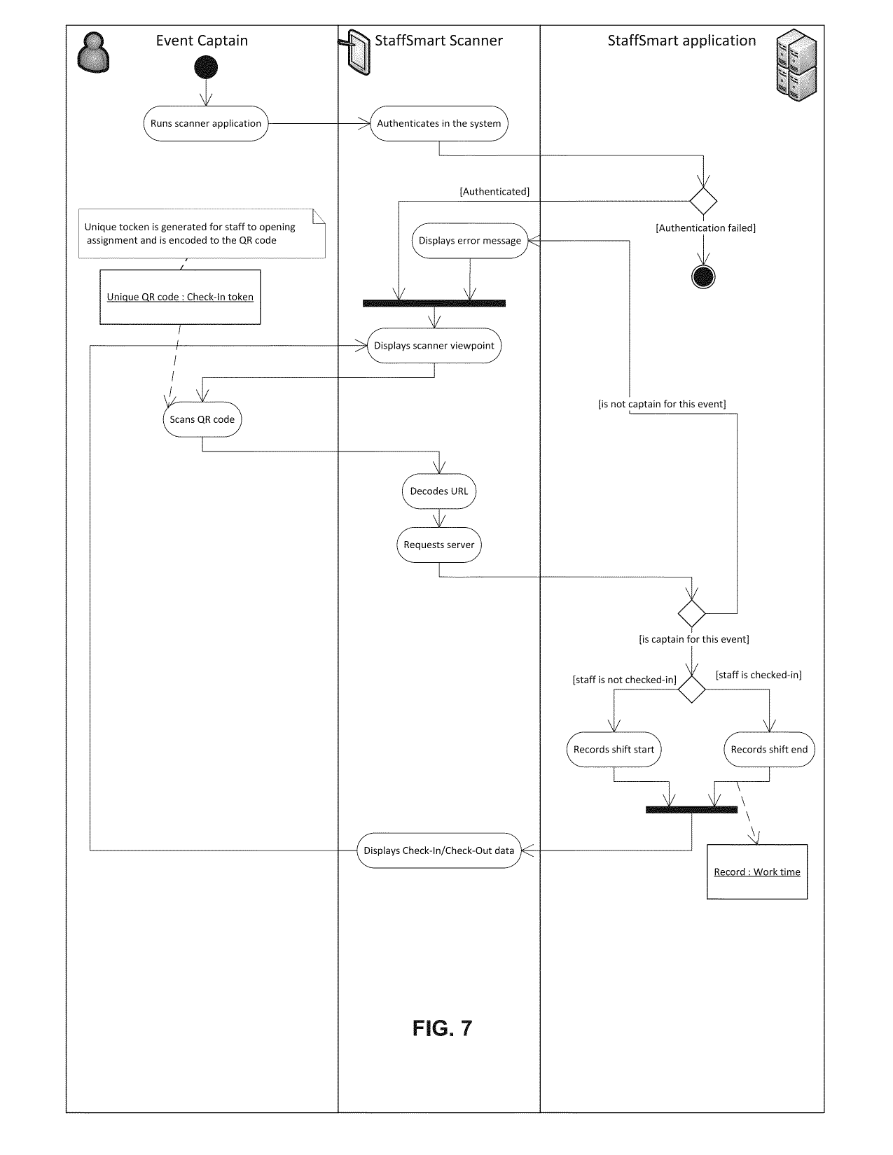

FIG. 7 depicts a process by which the Event Captain may utilize the StaffSmart Scanner application to check-in/check-out staff who report to an Event. Once authenticated, the captain may use this process to keep track of those staff who are present at the Event. The first scanning of the QR code may start the time clock on when that staff member checked in. The very last scan of the QR code ends the time clock and the system records the total hours. Intermediate scans of the code may be configured to be interpreted as check out and check in for lunch breaks.

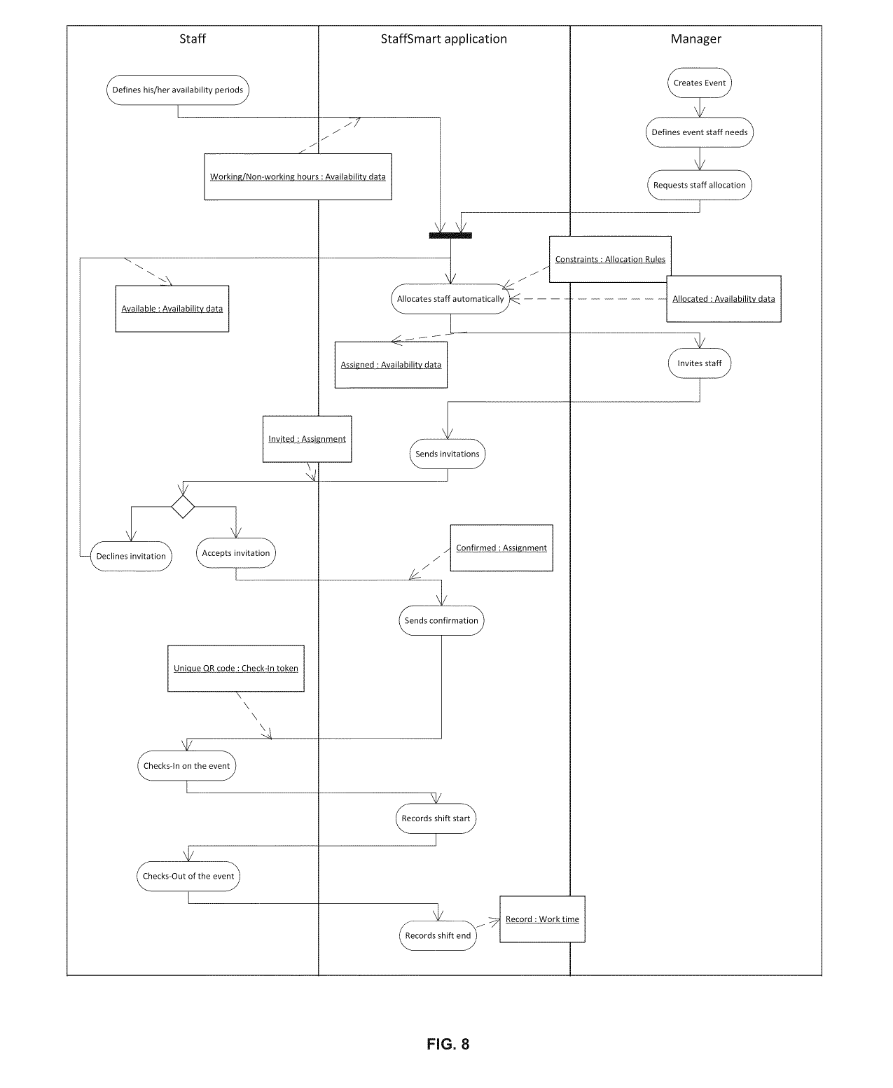

FIG. 8 depicts the entire system workflow process from the point in which the Staff defines his or her availability to the end point, at which the QR code is scanned for the check-out time and the system automatically records total hours worked.

The invention as described above may be applicable and useful for a variety of industries and fields such as for example a catering company (in particular when conducting off premise business), a temporary staffing agency (especially for a company who provides staff for large off-premise events, such as parties, sporting events, etc), an event production company (for example those companies that put up field events such as Country Music Awards, Tennis Tournaments, etc), a construction management company performing one or more large development projects and having a large staff working at various sites. Other potential uses are for management of emergency staff in the field, such as in triage situations, rescue situations, and other “one off” events. In embodiments, during initial setup, the system may be customized using certain preset configurations describing the general application of the system as well as certain typical field events. Examples of such configurations and typical events may include “Wedding”, “Lunch Buffet”, “Seated Dinner”, “Buffet”, “Tennis Tournament”, “New Construction, “Fashion Shoot”, etc. The system may also include a generic configurator that can be customized for other field events.

It is contemplated that any embodiment discussed in this specification can be implemented with respect to any method of the invention, and vice versa. It will be also understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, Aft AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12, 15, 20 or 25%.

All of the devices and/or methods disclosed and claimed herein can be made and executed without undue experimentation in light of the present disclosure. While the devices and methods of this invention have been described in terms of preferred embodiments, it will be apparent to those of skill in the art that variations may be applied to the devices and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

1. A computer-based system for allocation and management of field staff, the system comprising:
a central computer server having an automatic staff allocation engine configured to assign individual staff to a planned event, said staff allocation engine operably connected to a staff records keeping roster, a staff database including an individual staff profiles database and an individual availability database, an allocation rules database, and an automatic notification engine, said staff allocation engine is further configured to assign said individual staff based on ranked individual staff profile attributes and availability,
a manager user interface operably connected to said central computer server, said manager user interface is configured to create said planned event and request staff therefor, and
a plurality of individual staff communication devices configured to receive notifications from said automatic notification engine.

2. The system as in claim 1, wherein said plurality of individual staff communication devices further configured to register individual staff upon arrival to the planned event and keep track of working hours while at the planned event.

3. The system as in claim 2, wherein said automatic notification engine is further configured to generate individual barcodes and communicate said barcodes to said plurality of individual staff communication devices, said system further comprising a barcode reader to register individual staff upon arriving to the planned event and automatically record the working hours when leaving the planned event, said system further comprising a time tracking engine for recording the working hours for each individual staff.

4. The system as in claim 3, wherein said plurality of individual staff communication devices are further configured to allow individual staff to accept or reject notifications sent by said automatic notification engine, said system is further configured to generate further notifications to additional staff to compensate for rejections received from individual staff.

5. The system as in claim 3, wherein said barcodes are QR codes and said individual staff communication devices are mobile devices configured to display said QR codes.

6. The system as in claim 3, wherein said staff allocation engine is further configured to automatically generate additional staff notifications as needed or to compensate for previously notified staff who failed to check-in at the planned event within a predetermined period of time before or after the scheduled start time of said planned event.

7. The system as in claim 1, wherein said automatic staff allocation engine is configured for a manual override from said manager user interface.

8. A computer-based system for management of field staff, the system comprising:
a central computer server, and
a plurality of mobile devices for communication with individual staff,
wherein said central computer server is configured to generate individual notifications to at least a selected portion of said individual staff, communicate said notifications to respective mobile devices assigned to said selected portion of said individual staff, receive confirmations from at least a part of said selected portion of said individual staff, followed by generating and communicating individual barcodes to said part of said selected portion of the individual staff, said barcodes having limited time applicability corresponding to a timeframe for a planned event, the system is further configured to utilize each of said barcodes to (i) register an individual staff upon arrival to said event and start a record of working hours for said individual staff; and (ii) stop said record of working hours when said individual staff leaves said planned event, whereby recording a full account of working hours for said individual staff.

9. The system as in claim 8, wherein said individual barcodes are QR codes, said system is further equipped with a barcode reader operably connected to said system and configured to read said individual QR codes upon said individual staff arriving to and leaving from said planned event.

10. The system as in claim 8 further configured to cancel said individual barcode upon said individual staff leaving said planned event.

11. The system as in claim 8, wherein said mobile devices are smartphones or computer tablets equipped with a suitable display for displaying said individual barcodes and configured to communicate with said central computer server via a cellular, wireless or wired connection to an Internet.
